(19) United States
(12) Patent Application Publication
(10) Pub. No.: US 2026/0295807 A1
(43) Pub. Date: Oct. 1, 2026

(54) REACHER AND GRASPING TOOL

(71) Applicant: Unger Marketing International, LLC, Bridgeport, CT (US)

(72) Inventors: Brandon M. Temple, Stamford, CT (US); William Harrington, Newtown, CT (US); James M. Buckley, New Hartford, CT (US)

(21) Appl. No.: 19/631,072

(22) Filed: Mar. 27, 2026

Related U.S. Application Data
(60) Provisional application No. 63/779,022, filed on Mar. 27, 2025.

(51) Int. Cl. B25J 1/04; B25J 18/02

(52) U.S. Cl. CPC B25J 1/04; B25J 18/025

(57) ABSTRACT

A reaching and grabbing tool is provided. The tool includes a trigger assembly having a jaw actuation trigger and a trigger actuation gear. A jaw assembly is provided having a first jaw and a second jaw operably connected to the jaw actuation trigger to move the first jaw and the second jaw. A collar assembly is disposed between the trigger assembly and the jaw assembly, the collar assembly being selectively lockable to extend the tube to different lengths as desired by the user and to reduce the length of the tube to its smallest length for storage.

### CROSS-REFERENCE

This application claims the benefit of U.S. Provisional Application Ser. No. 63/779,022, filed Mar. 27, 2025, the entire disclosure of which is incorporated herein by reference.

### BACKGROUND

The subject matter disclosed herein relates to a reaching and grasping tool, and more particularly, to a reaching and grasping tool with an adjustable length.

Reaching and grasping tools have proven useful for extending the reach of users to, for example, grasp items above the user (e.g., on a shelf) or below the user (e.g., on the ground).

These tools typically have a trigger or actuator that causes a pair of gripping heads to open and close. The trigger and the gripping heads are separated by a pole. These types of tools may be configured with pistol or trigger-style grips. Other tools in this category are also known to be configured with inline-style grips.

While existing reaching and grasping tools are suitable for their intended purposes, the need for improvement remains, particularly in providing a reaching and grasping tool having the features described herein.

### BRIEF DESCRIPTION

According to one aspect of the disclosure a reaching and grabbing tool is provided. The tool includes a handle, a trigger assembly housed within the handle, a jaw assembly having a first jaw and a second jaw moveably coupled to a jaw housing via a pivot pin, a collar assembly disposed between the trigger assembly and the jaw assembly, the collar assembly being selectively lockable, and a tube extending between the handle and the jaw assembly, the tube having an inner tube slidingly nested within an outer tube and an inner rotating bar and outer rotating bar extending through the inner and outer tube.

In addition to one or more of the features described herein, or as an alternative, further embodiments of the tool may include the inner rotating bar being slidingly nested within the outer rotating bar and the inner rotating bar and the outer rotating bar are configured to rotate together.

In addition to one or more of the features described herein, or as an alternative, further embodiments of the trigger assembly may include a jaw actuation trigger, rotatably coupled to the handle and a trigger actuation gear rotationally engaged with the jaw actuation trigger.

In addition to one or more of the features described herein, or as an alternative, further embodiments of the jaw actuation trigger may include a central body, a plurality of slots formed on a front surface of the central body, and a plurality of teeth formed on a backside of the central body.

In addition to one or more of the features described herein, or as an alternative, further embodiments of the tool may include a ratchet switch having a plurality of teeth positioned to selectively engage the plurality of teeth of the jaw actuation trigger.

In addition to one or more of the features described herein, or as an alternative, further embodiments of the trigger actuation gear may include a plurality of protrusions configured to engage with the plurality of slots, the plurality of protrusions of the trigger actuation gear and the plurality of slots of the jaw actuation trigger cooperate to rotate the inner rotating bar.

In addition to one or more of the features described herein, or as an alternative, further embodiments of the tool may include the trigger actuation gear being rotationally coupled to the outer rotating bar.

In addition to one or more of the features described herein, or as an alternative, further embodiments of the tool may include a locking switch selectively engageable with the ratchet switch.

In addition to one or more of the features described herein, or as an alternative, further embodiments of the tool may include the plurality of teeth of the ratchet switch and the plurality of teeth of the jaw actuation trigger cooperating to hold the first jaw and the second jaw in a gripping position.

In addition to one or more of the features described herein, or as an alternative, further embodiments of the jaw assembly may include a jaw housing defining an interior cavity, housing the first jaw, the second jaw, and a jaw actuation gear, the jaw actuation gear including a plurality of protrusions, and the first jaw and the second jaw further comprising a body portion having a plurality of slots configured to engage the plurality of protrusions of the jaw actuation gear, wherein the plurality of protrusions of the jaw actuation gear and the plurality of slots of the body portion of the first jaw and the second jaw cooperate to move the first jaw and the second jaw between a first gripping position and a second gripping position.

In addition to one or more of the features described herein, or as an alternative, further embodiments of the tool may include the jaw actuation gear being rotationally coupled to the inner rotating bar.

In addition to one or more of the features described herein, or as an alternative, further embodiments of the collar assembly may include a tensioning mechanism, operably coupled to the tube, configured to allow the tube to be lengthened or shortened along a main axis defined by the tube.

In addition to one or more of the features described herein, or as an alternative, further embodiments of the first jaw may include a first grip surface and the second jaw includes a second grip surface, wherein the first grip surface and the second grip surface have a layer co-molded over at least a portion of an outer surface. The layer is made from thermoplastic elastomer.

According to one aspect of the disclosure a reaching and grabbing tool is provided. The tool includes a handle, a trigger assembly housed within the handle, a collar assembly disposed between the trigger assembly and the jaw assembly, the collar assembly being selectively lockable, a locking switch selectively engageable with the ratchet switch, and a tube extending between the handle and the jaw assembly, the tube having an inner tube slidingly nested within an outer tube and an inner rotating bar and outer rotating bar extending through the inner and outer tube, wherein the trigger actuation gear is rotationally coupled to the inner rotating bar and the jaw actuation gear is rotationally coupled to the outer rotating bar. The trigger assembly may include a jaw actuation trigger rotatably coupled to the handle, a trigger actuation gear rotationally engaged with the jaw actuation trigger, and a ratchet switch selectively engageable with the jaw actuation trigger, a jaw assembly having a jaw actuation gear and a first jaw and a second jaw moveably coupled to a jaw housing via a pivot pin

In addition to one or more of the features described herein, or as an alternative, further embodiments of the inner rotating bar may be slidingly nested within the outer rotating bar and the inner rotating bar and the outer rotating bar are configured to rotate together.

In addition to one or more of the features described herein, or as an alternative, further embodiments of the jaw actuation trigger may include a central body, a plurality of slots formed on a front surface of the central body, and a plurality of teeth formed on a backside of the central body, and the trigger actuation gear further comprises a plurality of protrusions configured to engage with the plurality of slots, the plurality of protrusions of the trigger actuation gear and the plurality of slots of the jaw actuation trigger cooperate to rotate the inner rotating bar.

In addition to one or more of the features described herein, or as an alternative, further embodiments of ratchet switch tool may include a plurality of teeth positioned to selectively engage the plurality of teeth of the jaw actuation trigger, wherein the plurality of teeth of the ratchet switch and the plurality of teeth of the jaw actuation trigger cooperate to hold the first jaw and the second jaw in a position.

In addition to one or more of the features described herein, or as an alternative, further embodiments of the jaw assembly may include a jaw housing defining an interior cavity, housing the first jaw, the second jaw, and the jaw actuation gear, the jaw actuation gear including a plurality of protrusions; and the first jaw and the second jaw further comprising a body portion having a plurality of slots configured to engage the plurality of protrusions of the jaw actuation gear, wherein the plurality of protrusions of the jaw actuation gear and the plurality of slots of the body portion of the first jaw and the second jaw cooperate to move the first jaw and the second jaw between a first position and a second position.

In addition to one or more of the features described herein, or as an alternative, further embodiments of the collar assembly may include a tensioning mechanism, operably coupled to the tube, configured to allow the tube to be lengthened or shortened along a main axis defined by the tube.

In addition to one or more of the features described herein, or as an alternative, further embodiments of the first jaw may include a first grip surface and the second jaw includes a second grip surface, wherein the first grip surface and the second grip surface have a layer co-molded over at least a portion of an outer surface.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a rear perspective view of a reaching and grasping tool in a collapsed position in accordance with an embodiment;

FIG. 2 is an unassembled view of the tool of FIG. 1 in accordance with an embodiment;

FIG. 3 is a front perspective view of the tool of FIG. 1 in accordance with an embodiment;

FIG. 4 is a side view of the tool of FIG. 1 in accordance with an embodiment;

FIG. 5 is a top view of the tool of FIG. 1 in accordance with an embodiment;

FIG. 6 is a bottom view of the tool of FIG. 1 in accordance with an embodiment;

FIG. 7 is a cross-sectional view of a handle assembly of the tool of FIG. 1 in accordance with an embodiment;

FIG. 8 is a rear perspective view of the trigger assembly within the handle assembly of the tool of FIG. 1 with one of the housing covers removed in accordance with an embodiment;

FIGS. 9A and 9B are a front and rear perspective view of the trigger actuation gear of the tool of FIG. 1 in accordance with an embodiment;

FIG. 10 is an unassembled view of a jaw assembly of the tool of FIG. 1 in accordance with an embodiment;

FIG. 11 is an interior perspective view of the jaw assembly of FIG. 10 with a cover portion removed in accordance with an embodiment;

FIG. 12 is a rear perspective view of the tool of FIG. 1 in an extended position in accordance with an embodiment;

FIG. 13 is a front perspective view of the tool of FIG. 12 in accordance with an embodiment;

FIG. 14 is a side cross-sectional view of the locking collar assembly in accordance with an embodiment;

FIG. 15 is a perspective view of a clip mechanism in accordance with an embodiment.

The detailed description explains embodiments of the disclosure, together with advantages and features, by way of example with reference to the drawings.

### DETAILED DESCRIPTION

A reaching and grasping tool 100 is provided. The reaching and grasping tool 100 has a jaw assembly with at least one jaw operatively connected to a trigger for movement with respect to a main axis A. In some embodiments, the jaw assembly defines at least one region configured to provide a plurality of gripping states. In some embodiments, the present disclosure provides for a reaching and grasping tool having a length that may be selectively changed to allow the distance from the jaw assembly to the trigger to be adjusted. In some embodiments, the tool 100 can include a rotation device. The rotation device is configured to allow rotation of the jaw assembly about the main axis A. The rotation device may allow rotation of the jaw assembly to any desired position or to a preselected position (e.g., every 15 degrees, every 45 degrees, every 65 degrees, etc.).

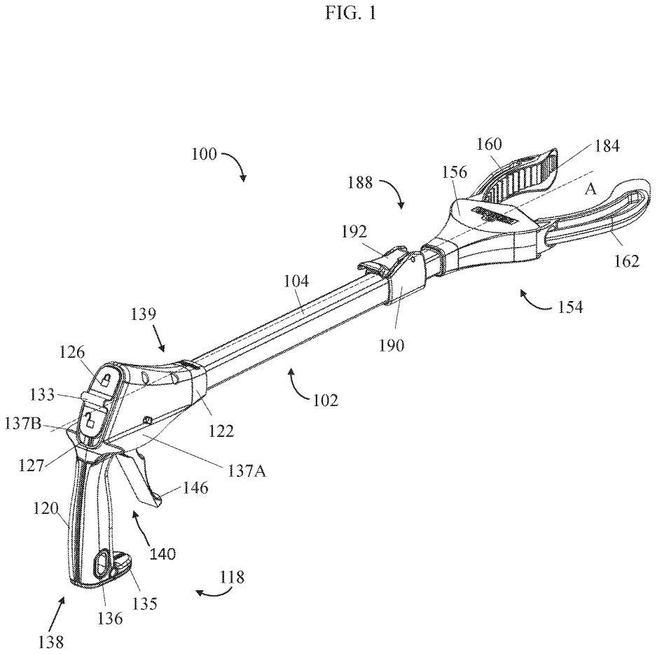

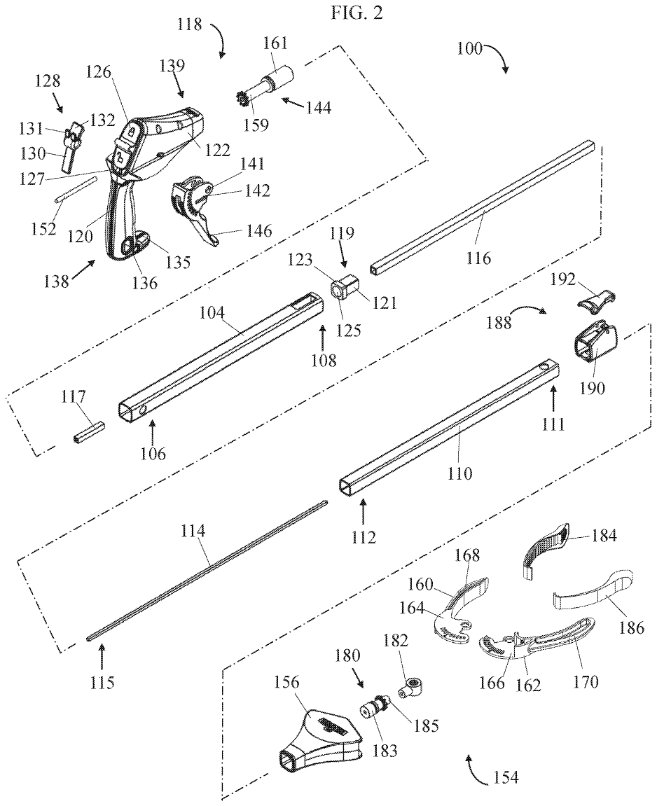

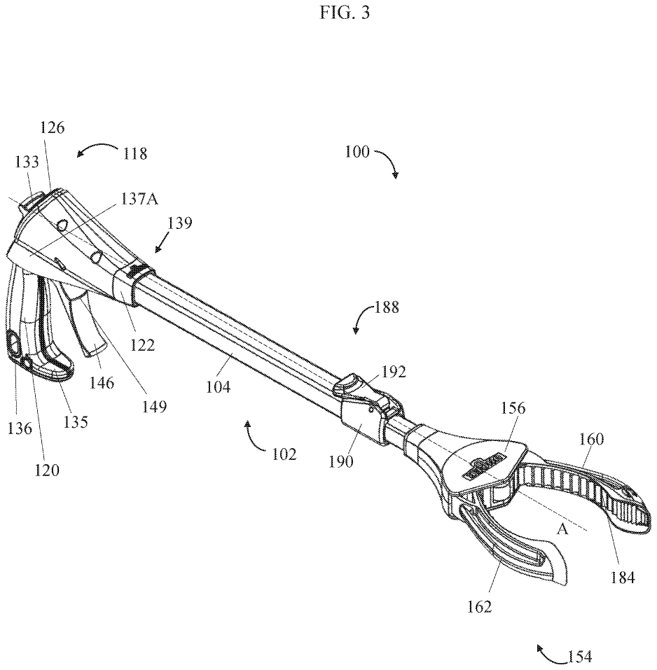

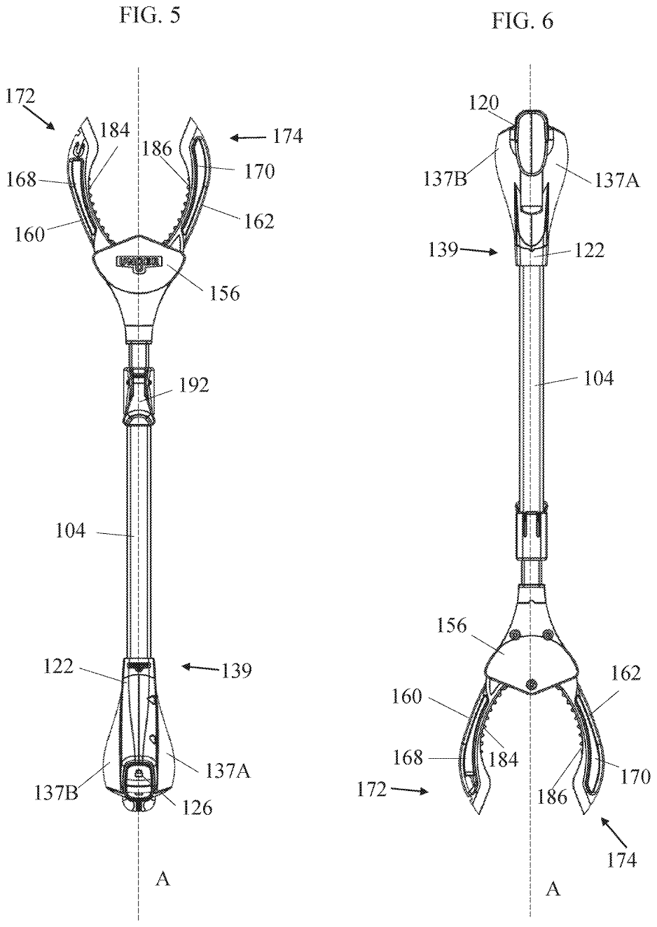

Referring now to FIGS. 1-6, an embodiment of the reaching and grasping tool 100 is shown. The reaching and grasping tool 100 includes a handle assembly 118, an extendable tube 102, a trigger assembly 140, a jaw assembly 154, and a collar assembly 188 disposed therebetween.

The extendable tube 102 includes an outer tube 104 and an inner tube 110. The inner tube 110 is nested within the outer tube 104 and is configured to slide freely within the outer tube 104, allowing the tool 100 to be extended or collapsed to a desired length. The outer tube 104 is coupled to the handle assembly 118, and the inner tube 110 is coupled to the jaw assembly 154. The extendable tube 102 further includes an inner rotating bar 114 and an outer rotating bar 116. The inner rotating bar 114 is nested within the outer rotating bar 116 and may also slide freely within the outer rotating bar 116. The nested inner and outer rotating bars 114, 116 are positioned within the inner tube 110 and outer tube 104, respectively. The inner and outer tubes 110, 104 and the inner and outer rotating bars 114, 116 may have a square shape, rounded square shape, rectangular shape, rounded rectangular shape, rounded triangular, or trilobal cross-section, and may be made from a metallic or composite material, such as, but not limited to: aluminum, steel, metallic alloys, fiberglass, carbon fiber and epoxy, wood, or a combination of the foregoing, with or without grips, texture, or surface treatments, for example. It should be appreciated that the geometry of the nested tubes and bars will have different diameters, radii, or other dimensions selected to allow for one structure to fit within and move freely relative to another structure, and may have the same geometric cross-sectional shape. In some embodiments, the inner and outer tubes 110, 104 may have a different geometric cross-sectional shape than the geometric cross-sectional shape of the inner and outer rotating bars 114, 116.

The inner and outer rotating bars 114, 116 are configured such that when a rotational force is applied to the outer rotating bar 116, the inner rotating bar 114 rotates as well. The outer rotating bar 116 and inner rotating bar 114 are operably coupled to the jaw assembly 154. Rotation of the inner and outer rotating bars 114, 116 causes reciprocating movement of the jaw assembly 154. The inner tube 110 is dimensioned larger than the inner and outer rotating bars 114, 116 such that the inner and outer rotating bars 114, 116 have clearance to rotate within the inner tube 110 without bumping or scraping an interior surface of the inner tube 110. In other words, the inner tube 110 includes a hollow interior that is sized to receive the inner and outer rotating bars 114, 116 and allow the inner and outer rotating bars 114, 116 to rotate freely therein.

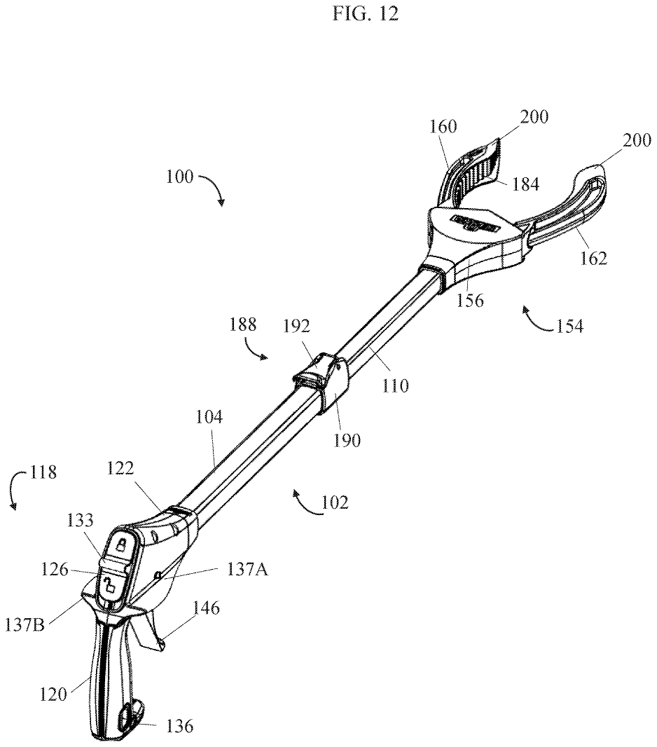

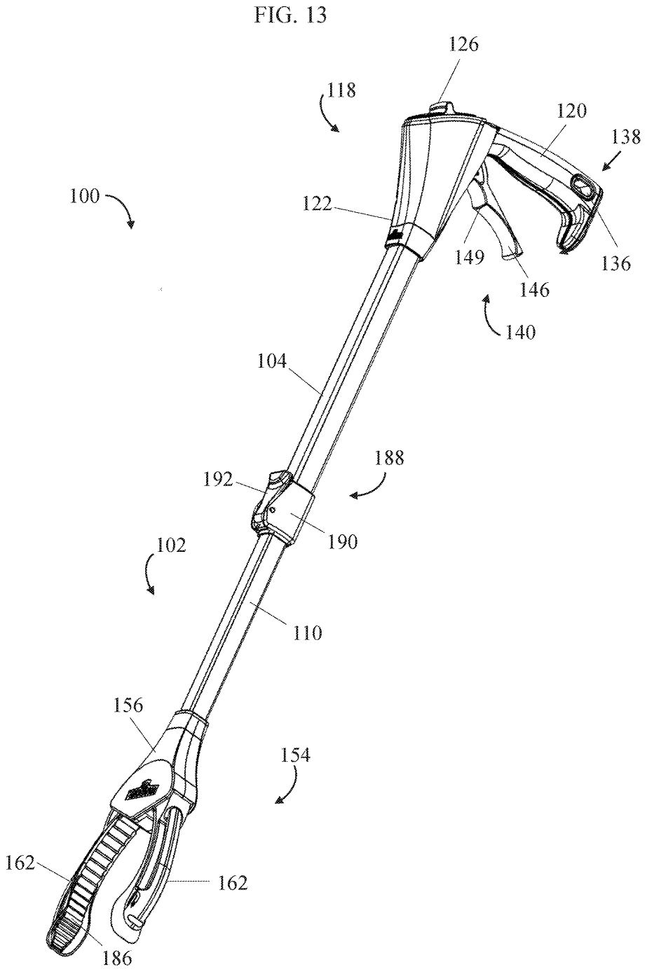

The collar assembly 188 is operably coupled to a distal end 108 of the outer tube 104. The handle assembly 118 is separated from the collar assembly 188 by the outer tube 104. In a collapsed position (FIG. 1), the extendable tube 102 is at its minimum length and the collar assembly 188 is adjacent to the jaw assembly 154. In an extended position (FIGS. 12 and 13), the extendable tube 102 is at its maximum length and the jaw assembly 154 is separated from the collar assembly 188 by the inner tube 110. The inner tube 110 translates along the main axis A of the tool 100 as the extendable tube 102 is moved from the collapsed position to the extended position, or to a selected position therebetween.

The extendable tube 102 may further include a cap piece 117 and a stopper 119. The cap piece 117 and stopper 119 cooperate to prevent the tube 102 from being extended beyond its maximum length. The cap piece 117 may have substantially the same shape as the inner and outer rotating bars 114, 116. The cap piece 117 encloses a proximal end 115 of the inner rotating bar 114. The cap piece 117 may be dimensioned larger than the inner rotating bar 114 and smaller than the outer rotating bar 116 such that the cap piece 117 fills any gap between the inner and outer rotating bars 114, 116. This improves the fit-connection between the inner and outer rotating bars 114, 116 such that the bars rotate together. The cap piece 117 includes a smooth surface so that it will slide freely with the inner rotating bar 114 as the tube 102 is extended and collapsed. In some embodiments, the cap piece 117 may be made from polyoxymethylene (POM), for example.

The stopper 119 includes a tail 121 and a head 123. The tail 121 may be dimensioned smaller than the head 123. The stopper 119 includes an opening 125 formed through the head 123 and tail 121. The tail 121 of the stopper 119 is positioned within the inner tube 110 with the head 123 disposed outside the proximal end 112 of the inner tube 110. The inner and outer rotating bars 114, 116 extend through the opening 125 of the stopper 119. As the tube 102 is extended to its maximum extended position, the stopper 119 abuts the cap piece 117, preventing the tube 102 from being extended beyond the maximum extended position.

The handle assembly 118 includes a handle body 120. In the illustrated embodiment, the handle body 120 is in the shape of a pistol grip or trigger style. The handle body 120 may include a foot 135 on a distal end 138 of the handle body 120. The foot 135 is an ergonomic feature of the handle assembly. A portion of the user's hand may rest against the foot 135 during use of the tool 100, thereby reducing strain on the user's hand during use of tool 100. The handle assembly 118 may further include at least one fin 137. The at least one fin 137 extends from the barrel portion 122, perpendicular to the main axis A. In some embodiments, the handle assembly 118 includes two fins 137A, 137B, positioned on opposite sides of the barrel portion 122. The fins 137A, 137B aid in maintaining the user's hand in the correct position when operating the tool 100. The fins 137A, 137B are additionally an ergonomic feature, supporting the user's hand while lifting the tool 100. The fins 137A, 137B terminate at a backside 129 of the handle body 120 and do not wrap around the backside, such that the user can operate a locking switch 126 with the same hand.

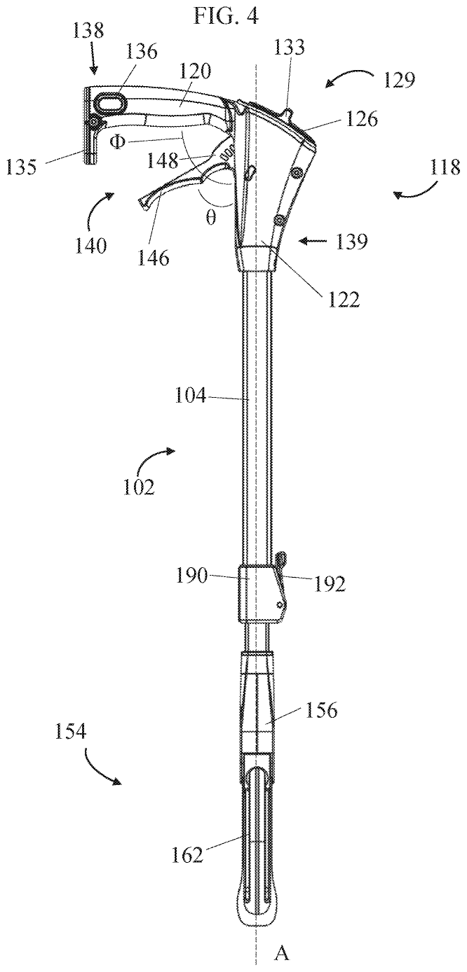

The handle body 120 may be formed in two halves that are then coupled together by a clip mechanism or a fastener, for example a screw, to define a hollow interior. In the illustrated embodiment, the handle body 120 is in the shape of a pistol grip or trigger style in which the handle body 120 extends at an angle Φ from the main axis A, as shown in FIG. 4. The angle Φ of the handle body 120 with respect to the main axis A may be any non-zero angle. In some embodiments, the non-zero angle ranges from 0 to 90 degrees, inclusive. In some embodiments, the non-zero angle is greater than 90 degrees.

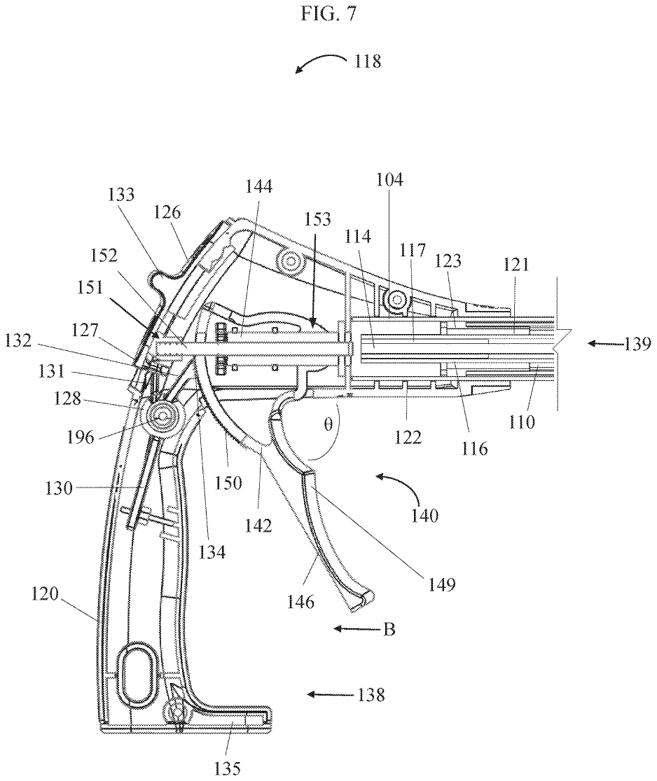

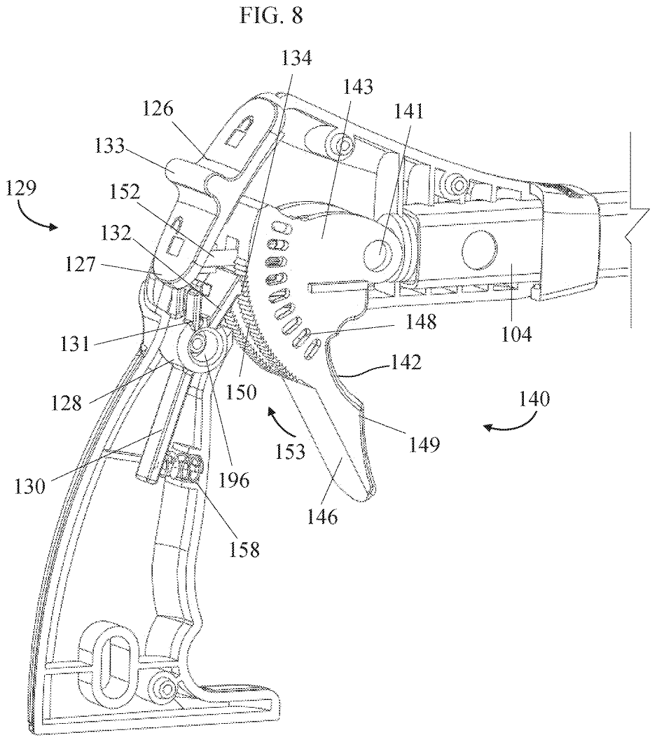

Referring to FIG. 7, the barrel portion 122 is located on a proximal end 139 of the handle assembly 118. The barrel portion 122 couples to a proximal end 106 of the outer tube 104. The proximal end 106 of the outer tube 104 may extend into the barrel portion 122. The handle assembly 118 further includes a locking switch 126 located on the backside 129 of the handle body 120. The locking switch 126 may have a rectangular or square shape with a ridge 133 transecting the width of the locking switch 126. The ridge 133 may be located substantially in the middle of the locking switch 126. In some embodiments, the ridge 133 may be located in the upper third area of the locking switch 126 or the lower third area of the locking switch 126. The locking switch 126 is translated between a locked position and an unlocked position. In the locked position, the locking switch 126 is translated away from the main axis A. In the unlocked position, the locking switch 126 is translated toward the main axis A. As the locking switch 126 is translated to the locked position, a bottom end 127 of the locking switch 126 disengages with a ratchet switch 128 to lock the trigger assembly 140 in a position, which in turn locks the jaw assembly 154, as described in more detail herein. The ratchet switch 128 is rotatably coupled to the handle body 120 by a pivot 196. The ratchet switch 128 includes an anchor-arm extension 130, a long-arm extension 132, and a short-arm extension 131 extending from the pivot 196. The anchor-arm extension 130 stabilizes the ratchet switch 128 as the short-arm extension 131 and long-arm extension 132 shift between a locked position and unlocked position, thereby locking and unlocking the trigger assembly 140. The handle body 120 further includes a hole 136 positioned on the distal end 138, opposite the barrel portion 122, for storing the tool 100 on a hook or similar means.

Referring to FIG. 8, with continuing reference to FIG. 7, the trigger assembly 140 is shown. The trigger assembly 140 is housed within the handle body 120. The trigger assembly 140 includes a jaw actuation trigger 142 and a trigger actuation gear 144. The jaw actuation trigger 142 is rotatably coupled to the handle body 120 by a pivot point 141. The pivot point 141 is formed in a central portion 143 of the jaw actuation trigger 142 and is positioned near the proximal end 106 of the outer tube 104. A trigger grip 146 extends from the central portion 143 of the jaw actuation trigger 142. The trigger grip 146 may extend at an angle θ from the main axis A (FIG. 4). The angle θ of the trigger grip 146 with respect to the main axis A may be any non-zero angle. In some embodiments, the non-zero angle ranges from 0 to 90 degrees, inclusive. In some embodiments, the non-zero angle is greater than 90 degrees. The trigger grip 146 may have a rectangular or square shape with a high point defining an apex 149. The apex 149 may be located in the middle of the trigger grip 146 such that at least one finger of a user may comfortably be placed on either side of the apex 149. In some embodiments, the apex 149 may be located in the upper third area of the trigger grip 146 such that at least one finger may comfortably be placed above the apex 149 and at least two fingers may comfortably be placed below the apex. In some embodiments, the apex 149 may be located in the lower third area of the trigger grip 146 such that at least two fingers may comfortably be placed above the apex 149 and at least one finger may comfortably be placed below the apex. The placement of the apex 149 allows for improved gripping of the jaw actuation trigger 142 and reduces strain on a user's hand.

The handle body 120 has a narrow width, enabling a user to toggle the locking switch 126 between the locked position and unlocked position with the thumb of the user's hand operating the tool 100, while at least one finger is engaging the jaw actuation trigger 142, without straining the user's thumb, finger, or hand generally.

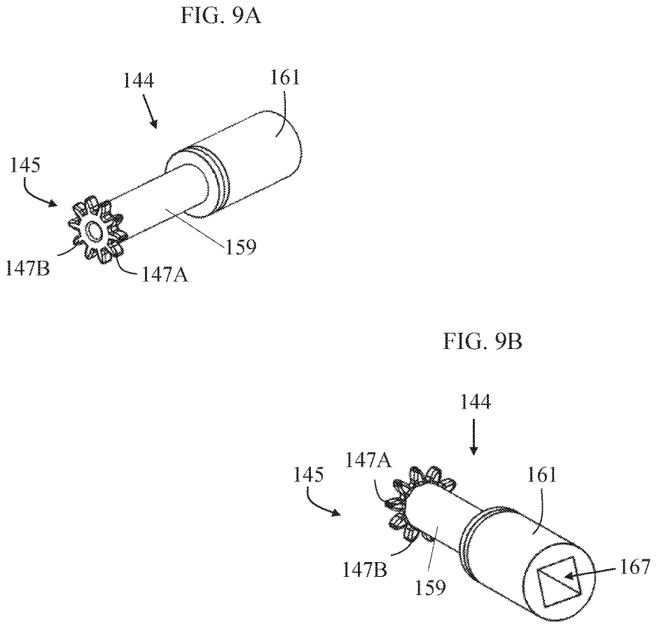

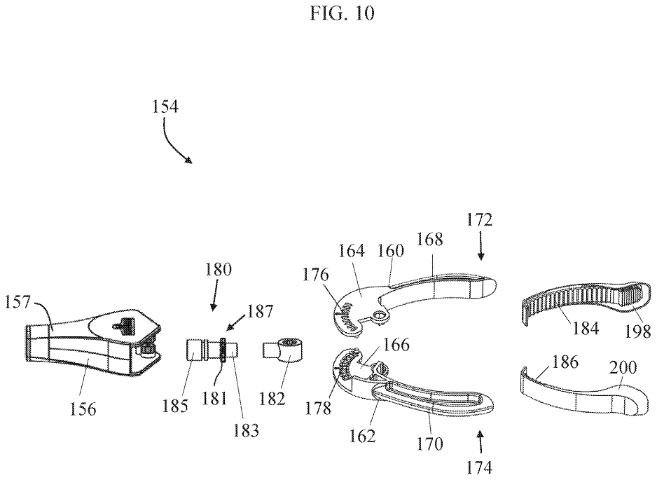

As the user squeezes the jaw actuation trigger 142, via the trigger grip 146, the jaw actuation trigger 142 rotates about the pivot point 141, causing the trigger actuation gear 144 to rotate. The trigger actuation gear 144 includes a first body 159 with a plurality of protrusions 147 (FIG. 9A) that engage with a plurality of openings or slots 148 formed in the central portion 143 of the jaw actuation trigger 142. Rotation of the jaw actuation trigger 142 causes reciprocating rotation of the trigger actuation gear 144 via the engagement between the plurality of slots 148 and the plurality of protrusions 147. The plurality of protrusions 147 may extend perpendicular from the first body 159 of the trigger actuation gear 144 about the circumference of the first body 159. In some embodiments, the plurality of protrusions 147 may form a wheel-like shape 145. The trigger actuation gear 144 further includes a second body 161, with the first and second bodies 159, 161 being connected, as shown in FIGS. 9A and 9B. The first body 159 and the second body 161 may have substantially cylindrical shapes. The first body 159 has a diameter dimensioned smaller than a diameter of the second body 161 and has a length dimensioned substantially equal to the length of the second body 161. In some embodiments, the first body 159 diameter is substantially equal to the second body 161 diameter. In some embodiments, the length of the first body 159 is dimensioned longer than the length of the second body 161.

The second body 161 is operably coupled to the outer rotating bar 116. The outer rotating bar 116 is positioned inside an opening 167 formed within the second body 161. The opening 167 may have the same shape as the outer rotating bar 116, ensuring a friction fit. Accordingly, as the trigger actuation gear 144 is rotated (i.e., as the jaw actuation trigger is rotated), the inner and outer rotating bars 114, 116 are rotated, thereby actuating the jaw assembly 154 (described further below).

As the jaw actuation trigger 142 is squeezed by a user and translated toward the handle body 120 in the direction of arrow B (FIG. 7), a first slot 148 (FIG. 8) is rotated into position where it catches and engages with a first protrusion 147 of the trigger actuation gear 144. As the jaw actuation trigger 142 continues to be translated in the direction of arrow B, the first slot engaged with the first protrusion 147A rotates the trigger actuation gear 144 and a second slot 148 catches and engages with a second protrusion 147B. After the slot rotates the protrusion a predetermined distance, the protrusion disengages from the slot. It should be appreciated that the engagement of the protrusions 147 with the slots 148 continues as the jaw actuation trigger 142 continues to be pulled toward the handle body 120, in the direction of arrow B.

The trigger assembly 140 may include a pin 152 with a first end 151 (FIG. 7) coupled to an interior side of the backside 129 of the handle body 120, extending through the jaw actuation trigger 142, and a second end 153 (FIG. 7) coupled to the trigger actuation gear 144. In some embodiments, the second end 153 extends through the center of the wheel body 145 of the trigger actuation gear 144. In some embodiments, the first body 159 of the trigger actuation gear 144 includes a central opening formed therethrough configured to receive the second end 153 and a portion of the pin 152. The pin 152 may extend through a portion or the entire length of the first body 159 of the trigger actuation gear 144. The pin 152 holds the trigger actuation gear 144 in the desired axial alignment such that the trigger assembly functions efficiently and as intended. The pin 152 also supports the trigger actuation gear 144 so that it does not put unnecessary weight or force on the jaw actuation trigger 142, causing undue wear and tear on the jaw actuation trigger 142.

The jaw actuation trigger 142 further includes a plurality of teeth 150 formed on a backside or second end 153 of the central portion 143 of the jaw actuation trigger 142. The plurality of teeth 150 engage with a plurality of gear teeth 134 formed on an end of the short-arm extension 132 of the ratchet switch 128 to lock the jaws in a desired gripping position. In embodiments that include the pin 152, the central portion 143 of the jaw actuation trigger 142 includes a gap or space intersecting the backside or second end 153 of the central portion 143 longitudinally, such that the jaw actuation trigger 142 can rotate freely without the pin 152 restricting its movement.

To hold the jaw assembly 154 in a desired gripping position, the locking switch 126 is translated from the unlocked position to the locked position to engage the ratchet switch 128 with the jaw actuation trigger 142. A biasing member (not pictured), such as a spring, is coupled between the long-arm and short-arm extensions 132, 131. In the locked position, the bottom end 127 of the locking switch is in contact with the short-arm extension 131. When the bottom end 127 is in contact with the short-arm extension 131, the biasing member applies a force against the long-arm extension 132, moving the long-arm extension 132 toward the jaw actuation trigger 142 such that a plurality of teeth 134 formed on an end of the long-arm extension 132 engage with the plurality of teeth 150 of the jaw actuation trigger 142. The engagement of the plurality of teeth 134, 150 locks the trigger assembly 140 and the jaw assembly 154 in a desired gripping position.

As the locking switch 126 is translated into the unlocked position, the bottom end 127 of the locking switch 126 disengages from the short-arm extension 131. The movement of the short-arm extension 131 releases the biasing member, thereby removing the force applied to the long-arm extension 132 by the biasing member. With the force removed, the plurality of teeth 134 of the long-arm extension 132 are no longer engaged with the plurality of teeth 150 of the jaw actuation trigger, thereby releasing the trigger assembly 140 and jaw assembly 154 to rotate. Accordingly, the user is able to lock the jaw assembly 154 in any gripping position they desire and release the jaw assembly 154 to move. As a result, the user may select the amount of force to apply to the gripped item and lock the jaws in the position needed to maintain that force without having to continuously squeeze the jaw actuation trigger 142.

In an embodiment, the ratchet switch 128 includes a biasing member 158, for example a spring, positioned between the anchor-arm extension 130 and a wall of the handle body 120. The biasing member 158 aids in maintaining a connection between the plurality of teeth 134, 150. The biasing member 158 applies a force against the anchor-arm extension 130, which applies a torque force on the long-arm extension 132. The force is removed when the locking switch 126 is in the unlocked position.

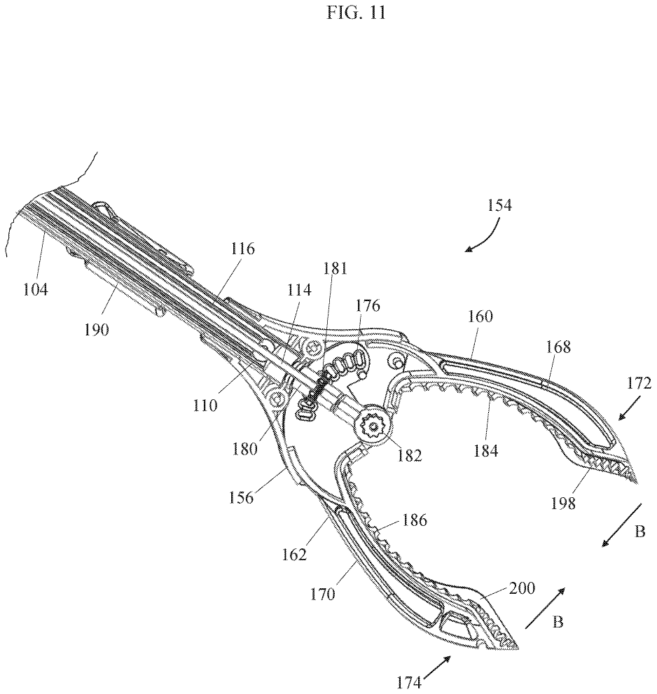

Referring now to FIGS. 10-11, an embodiment of the jaw assembly 154 is shown in an open position. The jaw assembly 154 includes a jaw housing 156 that may be formed in two halves that are then coupled together by a clip mechanism or a fastener, for example a screw, to define a hollow interior. The jaw housing 156 may include a tubular portion 157. The tubular portion 157 couples to a distal end 111 of the inner tube 110. The inner tube 110 may extend into the tubular portion 157. The inner and outer rotating bars 114, 116 may also extend into the tubular portion 157. The jaw assembly 154 further includes a first jaw 160 and a second jaw 162. The first and second jaws 160, 162 each include a body portion 164, 166 with an arm portion 168, 170 extending from the body portion 164, 166, respectively. In some embodiments, the arm portions 168, 170 may have an arcuate shape. In some embodiments, the arm portions 168, 170 may have a shallow-curve shape.

In some embodiments, either the first jaw 160 or the second jaw 162 is fixed and the other jaw is movably coupled to the fixed jaw. In this embodiment, the movable jaw 160 or 162 is operatively coupled to a jaw actuation gear 180 so as to move that jaw 160 or 162 between a closed position, an open position, and a gripping position therebetween.

In some embodiments, the first jaw 160 and the second jaw 162 are both movably coupled to the jaw actuation gear 180. The first and second jaws 160, 162 are configured to rotate about a pivot pin 182 to translate between the closed position and the open position. When in the open position, a distal end 172, 174 of the first and second jaws 160, 162, respectively, are separated (see e.g., FIG. 11).

The body portions 164, 166 of the first and second jaws 160, 162 are disposed within the hollow area of the jaw housing 156. The body portion 164 of the first jaw 160 is disposed on top of the body portion 166 of the second jaw 162, with the jaw actuation gear 180 disposed therebetween. The body portions 164, 166 include a plurality of openings or slots 176, 178 opposite the pivot pin 182, respectively. The plurality of slots 176, 178 may form an arc. The arc shape allows for rotation of the first and second jaws 160, 162 while the jaw actuation gear 180 rotates in a fixed location.

The jaw actuation gear 180 may be disposed between the first jaw 160 and the second jaw 162. Similar to the trigger actuation gear 144, the jaw actuation gear 180 includes a body with a plurality of protrusions 181 extending perpendicular from the body of the jaw actuation gear 180 about the circumference of the body. The plurality of protrusions 181 engage with the plurality of slots 176, 178 formed in the body portions 164, 166 of the first and second jaws 160, 162. The plurality of protrusions 181 of the jaw actuation gear 180 may be dimensioned longer than the plurality of protrusions 147 of the trigger actuation gear 144 to engage with the plurality of slots 176 and the plurality of slots 178 located above and below the jaw actuation gear 180. Positioning the jaw actuation gear 180 between the first jaw 160 and the second jaw 162 provides for efficient control of the jaws 160, 162 and improves the freedom of movement of the jaws 160, 162. Less force is required to rotate and articulate the first and second jaws 160, 162 to different grasping positions. Additionally, the increased space between the body portions 164, 166 allows the first and second jaws 160, 162 to rotate freely.

The jaw actuation gear 180 may include a first body 183 and a second body 185. The plurality of protrusions 181 may form a wheel-like shape 187 around the first body 183. The first body 183 and second body 185 are connected and may have substantially cylindrical shapes. The first body 183 has a diameter dimensioned smaller than a diameter of the second body 185 and has a length dimensioned longer than the length of the second body 185. The length of the first body 183 of the jaw actuation gear 180 may be dimensioned shorter than the length of the first body 183 of the trigger actuation gear 144.

The second body 185 is operably coupled to the inner rotating bar 114 (FIG. 11). The inner rotating bar 114 is positioned in an opening formed within the second body 185, as shown in FIG. 11. Accordingly, as the inner and outer rotating bars 114, 116 are rotated, the jaw actuation gear 180 is rotated, thereby actuating the first and second jaws 160, 162.

The nested inner and outer rotating bars 114, 116 extend through the length of the inner and outer tubes 104, 110, and the inner rotating bar 114 couples to the jaw actuation gear 180. As the inner rotating bar 114 rotates, the jaw actuation gear 180 is rotated. As the jaw actuation gear 180 rotates, a first protrusion 181 is rotated into position to catch and engage with a first slot 176 of the first and second jaws 160, 162. As the jaw actuation gear 180 continues to rotate, the first protrusion 181 engaged with the first slot 176 rotates the first and second jaws 160, 162. The first and second jaws 160, 162 rotate about the pivot pin 182, causing the arm portions 168, 170 to move in a direction indicated by arrow B (FIG. 11). As the jaw actuation gear 180 continues to rotate, the first protrusion engaged with the first slot 176 of the first and second jaws 160, 162 rotates the first and second jaws 160, 162, and a second protrusion 181 catches and engages with a second slot 176 of the first and second jaws 160, 162. After the protrusion 181 rotates the slots a predetermined distance, the protrusion disengages from the slot. This engagement and disengagement of the protrusions 181 from the slots 176 continues as long as the trigger grip 146 rotates. The trigger grip 146 will be prevented from further rotation once the first and the second jaws 160, 162 either grip an object or the first and the second jaws 160, 162 are pressed together in the closed position.

It should be appreciated that when the user is releasing the trigger grip 146 to move the first and second jaws 160, 162 into the open position, the first and second jaws 160, 162 move in opposite directions, away from each other. When the user is squeezing the trigger grip 146 to move the first and second jaws 160, 162 into the closed position, the first and second jaws 160, 162 move toward each other.

It should also be appreciated that when the trigger grip 146 is moved in the direction of arrow B and in a direction opposite to arrow B, the engagement of the protrusions of the trigger actuation gear 144 and the plurality of slots 148 causes the inner and outer rotating bars 114, 116 to rotate, and the engagement of the protrusions of the jaw actuation gear 180 and the plurality of slots 176, 178 will cause the first and second jaws 160, 162 to rotate about the pivot pin 182 to the closed position, where the first and second jaws 160, 162 are pressed together, or to a grasping position where an object is grasped between the first and the second jaws 160, 162 (or into the open position when the trigger grip 146 moves away from the handle body 120). As described above, the first and second jaws 160, 162 can be locked/fixed in a certain rotational gripping position by translating the locking switch 126 to engage the ratchet switch 128 with the jaw actuation trigger 142.

The first and second jaws 160, 162 each have a grip surface 184, 186 that allows for multiple sizes of objects to be grasped therebetween. In some embodiments, the grip surfaces 184, 186 include a layer made from a soft and non-slip material. In some embodiments, the grip surface 184, 186 may be a co-molded layer and may be made from one or more of polyester, polypropylene (PP), polyvinyl chloride (PVC), thermoplastics, or thermoplastic elastomer (TPE), for example. In some embodiments, a distal end of the grip surfaces 184, 186 may include a plurality of grooves, ridges, or teeth near the distal end of the first and second jaws 172, 174 (FIG. 11). The plurality of grooves, ridges, or teeth are cross-meshed. This allows for a “sealed” grip and aids in eliminating flat gaps that occur between flat surfaces or textured surfaces that are not cross-meshed. The plurality of ridges are defined by a plurality of adjacent triangularly shaped slots that extend through the width of the grip surfaces 184, 186. The remaining area of the grip surfaces 184, 186 may include a plurality of u-shaped slots (see e.g., FIG. 11). The slots are inwardly facing when the first and second jaws 160, 162 are in the closed position. It should be appreciated that while two grip surface-features of the grip surfaces 184, 186 are described, this is for example purposes only. In other embodiments, the grip surfaces 184, 186 may have no grip surface-features, one grip surface-feature, or three or more grip surface-features. For example, a proximal end of the first and second grip surfaces 184, 186, near the body portion 164, 166 of the first and second jaws 160, 162, may include a plurality of teeth. The grip surface-features allow for gripping the object held in the first and the second jaws 160, 162. In some embodiments, the grip surface 184, 186 includes an angled surface that extends at an angle ranging from 0 to 60 degrees relative to a plane extending through the center of the tool 100. In some embodiments, the grip surface 184, 186 includes a flap 198, 200, respectively, extending substantially perpendicular from the grip surface 184, 186. The flap 198, 200 may be more flexible than the other grip surface-features. The flap 198, 200 may overlap the object being grasped between the grip surfaces 184, 186 to enhance the hold of the jaw assembly on the object. In an embodiment, the flap 198, 200 is co-molded/over-molded.

In some embodiments, the first jaw 160 or the second jaw 162 may have a projection (not pictured) disposed on a side opposite the second jaw 162 or the first jaw 160. The projection may be in the shape of a hook, defining a generally U-shaped slot. It should be appreciated that the projection provides advantages in allowing the user to pick up items with the projection that may be difficult to grasp with the first and second jaws 160, 162. The projection may also be used for hanging the reaching and grasping tool 100 when not in use.

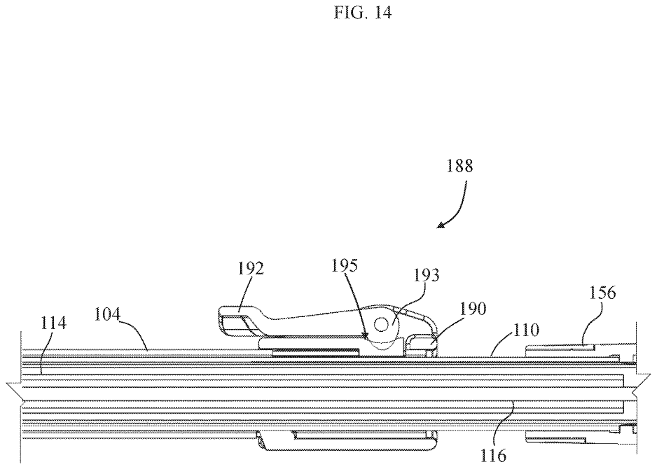

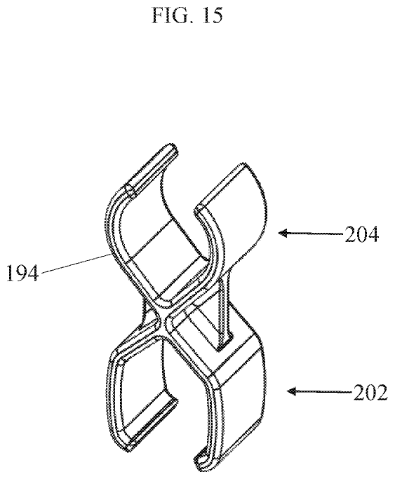

Referring now to FIGS. 1-4 and 12-14, an embodiment of the collar assembly 188 is shown. The collar assembly 188 allows for the selective extension and locking/fixing of the inner tube 110 and outer tube 104 at a desired length. The collar assembly 188 includes a collar sheath 190 and a lever 192. The collar sheath 190 and lever 192 include protrusions to form a hinged connection therebetween. The collar sheath 190 is dimensioned greater than the outer tube 104 and is coupled on an exterior surface at a proximal end 106 of the outer tube 104 and is shaped substantially the same as the tube 102 (see FIG. 12). The lever 192 includes a cam portion 193 that is arranged to extend through an opening 195 in the collar sheath 190 and selectively engage the outer surface of the inner tube 110 (see FIG. 14). When the lever 192 is in a released position, the cam portion 193 is rotated away from the outer surface of the inner tube 110, and the outer tube 104 and inner tube 110 may translate freely relative to each other. The tool 100 may be extended to a length as shown in FIGS. 12 and 13, for example. When the tube 102 is at the desired length, the lever 192 is rotated to the locked position, causing the cam portion 193 to engage the outer surface of the inner tube 110. In the locked position, the lever 192 applies a clamping force on the inner tube 110 with the cam portion 193, securing the outer and inner tubes 104, 110 in place. In some embodiments, the lever 192 can include fins or protrusions that insert into reciprocating divots of the collar sheath, as the collar assembly is locked, to provide a greater clamping force.

The tube 102 is selectively locked at a certain length until the user lifts the lever 192 to the released position. When the lever 192 is in the released position, the tube 102 may again be adjusted to a different length. It should be appreciated that the ability to adjust the length of the tool 100 provides advantages in setting the tool 100 to the length needed at a given moment and in reducing the length to facilitate storage or transportation of the tool 100. It should further be appreciated that the ability to change the length of the reaching and grasping tool 100 provides advantages in reducing the length of the reaching and gasping tool 100 to facilitate storage or transportation of the reaching and grasping tool 100, such as by allowing it to be stored in a drawer or carried in a handbag, for example.

Referring to FIG. 15, in some embodiments, the tool 100 may include a clip mechanism 194 coupled to the tube 102. The clip mechanism 194 may include a bottom portion 202 that is coupled to the inner tube 110 or the outer tube 104. In some embodiments, the clip mechanism 194 is permanently attached to the inner tube 110 or the outer tube 104. In some embodiments, the clip mechanism 194 is removably attached to the inner tube 110 or the outer tube 104. This allows a user to place the clip mechanism 194 at a desired location on the tube 102 depending on where the user stores the tool 100. A user may store the tool 100 on a bar by clasping a top portion 204 of the clip mechanism 194 around the bar. For example, a user can store the tool 100 on the tubular frame of a wheelchair or walker. This way, the tool 100 can always be within arm's reach without having it hang off the side of the wheelchair or walker where it might get in the way. The clip mechanism 194 may have a substantially “C” shape with rounded arms. In some embodiments, the clip mechanism may have a substantially “C” shape with polygonal arms. For example, a plurality of straight segments are used to form a substantially “C” shape.

The term “about” is intended to include the degree of error associated with measurement of the particular quantity based upon the equipment available at the time of filing the application.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection”. It should also be noted that the terms “first”, “second”, “third”, “upper”, “lower”, and the like may be used herein to modify various elements. These modifiers do not imply a spatial, sequential, or hierarchical order to the modified elements unless specifically stated.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A reaching and grabbing tool comprising:
a handle;
a trigger assembly housed within the handle;
a jaw assembly having a first jaw and a second jaw moveably coupled to a jaw housing via a pivot pin;
a collar assembly disposed between the trigger assembly and the jaw assembly, the collar assembly being selectively lockable; and
a tube extending between the handle and the jaw assembly, the tube having an inner tube slidingly nested within an outer tube and an inner rotating bar and outer rotating bar extending through the inner and the outer tube.

2. The tool of claim 1, wherein the inner rotating bar is slidingly nested within the outer rotating bar and the inner rotating bar and the outer rotating bar are configured to rotate together.

3. The tool of claim 1, wherein the trigger assembly further comprises:
a jaw actuation trigger, rotatably coupled to the handle; and
a trigger actuation gear rotationally engaged with the jaw actuation trigger.

4. The tool of claim 3, wherein the jaw actuation trigger further comprising:
a central body,
a trigger grip extending from the central body,
a plurality of slots formed on a side surface of the central body, and
a plurality of teeth formed on a backside of the central body.

5. The tool of claim 4, further comprising a ratchet switch housed within the handle, having a plurality of teeth positioned to selectively engage the plurality of teeth of the jaw actuation trigger.

6. The tool of claim 4, wherein the trigger actuation gear further comprises a plurality of protrusions configured to engage with the plurality of slots, the plurality of protrusions of the trigger actuation gear and the plurality of slots of the jaw actuation trigger cooperate to rotate the outer rotating bar.

7. The tool of claim 3, wherein the trigger actuation gear is rotationally coupled to the outer rotating bar.

8. The tool of claim 5, further comprising a locking switch selectively engageable with the ratchet switch.

9. The tool of claim 5, wherein the plurality of teeth of the ratchet switch and the plurality of teeth of the jaw actuation trigger cooperate to hold the first jaw and the second jaw in a gripping position.

10. The tool of claim 1, wherein:
the jaw assembly further comprises a jaw housing defining an interior cavity, housing a body portion of the first jaw, a body portion of the second jaw, and a jaw actuation gear, the jaw actuation gear including a plurality of protrusions; and the body portion of the first jaw and the second jaw have a plurality of slots configured to engage the plurality of protrusions of the jaw actuation gear, and
the plurality of protrusions of the jaw actuation gear and the plurality of slots of the body portion of the first jaw and the second jaw cooperate to move the first jaw and the second jaw between a first gripping position and a second gripping position.

11. The tool of claim 10, wherein the jaw actuation gear is rotationally coupled to the inner rotating bar.

12. The tool of claim 1, wherein the collar assembly further comprises a tensioning mechanism, operably coupled to the tube, configured to allow the tube to be lengthened or shortened along a main axis defined by the tube.

13. The tool of claim 1, wherein the first jaw includes a first grip surface and the second jaw includes a second grip surface, wherein the first grip surface and the second grip surface have a layer co-molded over at least a portion of an outer surface.

14. A reaching and grabbing tool comprising:
a handle;
a trigger assembly housed within the handle, comprising:
a jaw actuation trigger rotatably coupled to the handle,
a trigger actuation gear rotationally engaged with the jaw actuation trigger, and
a ratchet switch selectively engageable with the jaw actuation trigger;
a jaw assembly having a jaw actuation gear and a first jaw and a second jaw moveably coupled to a jaw housing via a pivot pin;
a collar assembly disposed between the trigger assembly and the jaw assembly, the collar assembly being selectively lockable;
a locking switch selectively engageable with the ratchet switch; and
a tube extending between the handle and the jaw assembly, the tube having an inner tube slidingly nested within an outer tube and an inner rotating bar and outer rotating bar extending through the inner and the outer tube,
wherein the trigger actuation gear is rotationally coupled to the outer rotating bar and the jaw actuation gear is rotationally coupled to the inner rotating bar.

15. The tool of claim 14, wherein the inner rotating bar is slidingly nested within the outer rotating bar and the inner rotating bar and the outer rotating bar are configured to rotate together.

16. The tool of claim 14, wherein the jaw actuation trigger further comprises a central body, a trigger grip extending from the central body, a plurality of slots formed on a side surface of the central body, and a plurality of teeth formed on a backside of the central body, and the trigger actuation gear further comprises a plurality of protrusions configured to engage with the plurality of slots, the plurality of protrusions of the trigger actuation gear and the plurality of slots of the jaw actuation trigger cooperate to rotate the inner rotating bar.

17. The tool of claim 14, wherein the ratchet switch further comprising a plurality of teeth positioned to selectively engage the plurality of teeth of the jaw actuation trigger, wherein the plurality of teeth of the ratchet switch and the plurality of teeth of the jaw actuation trigger cooperate to hold the first jaw and the second jaw in a position.

18. The tool of claim 14, wherein:
the jaw assembly further comprises a jaw housing defining an interior cavity, housing the first jaw, the second jaw, and the jaw actuation gear, the jaw actuation gear including a plurality of protrusions; and the first jaw and the second jaw further comprising a body portion having a plurality of slots configured to engage the plurality of protrusions of the jaw actuation gear, and
the plurality of protrusions of the jaw actuation gear and the plurality of slots of the body portion of the first jaw and the second jaw cooperate to move the first jaw and the second jaw between a first position and a second position.

19. The tool of claim 14, wherein the collar assembly further comprises a tensioning mechanism, operably coupled to the tube, configured to allow the tube to be lengthened or shortened along a main axis defined by the tube.

20. The tool of claim 14, wherein the first jaw includes a first grip surface and the second jaw includes a second grip surface, wherein the first grip surface and the second grip surface have a layer co-molded over at least a portion of an outer surface.
